(19) United States
(12) Patent Application Publication
(10) Pub. No.: US 2010/0272459 A1
(43) Pub. Date: Oct. 28, 2010

(54) IMAGE FORMING APPARATUS AND FIXING DEVICE HEATING METHOD

(75) Inventor: Hidenori KOBAYASHI, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/764,750

(22) Filed: Apr. 21, 2010

Related U.S. Application Data
(60) Provisional application No. 61/173,066, filed on Apr. 27, 2009.
(60) Provisional application No. 61/173,072, filed on Apr. 27, 2009.

(51) Int. Cl. G03G 15/20

(52) U.S. Cl. 399/69

(57) ABSTRACT

An image forming apparatus includes: a fixing device temperature information acquisition unit which acquires information about temperature of a fixing device; and a fixing device heating control unit which controls heating of the fixing device, using at least the information about the temperature of the fixing device acquired by the temperature information acquisition unit so that the fixing device reaches a target temperature within a time period from first timing by which an operation input to start copying becomes acceptable to second timing when a printing command for copying becomes issuable.

### CROSS-REFERENCE TO RELATED APPLICATION

This application is based upon and claims the benefit of priority from: U.S. provisional application Nos. 61/173066, filed on Apr. 27, 2009; and 61/173072, filed on Apr. 27, 2009; the entire contents of each of which are incorporated herein by reference.

### TECHNICAL FIELD

The present invention relates to heating control of a fixing device provided in an image forming apparatus.

### BACKGROUND

In conventional MFPs, when power is turned on, startup is started simultaneously on all connected units involved in performing functions provided for the MFP. It is known that, of these units, warm-up of a fixing device takes a large proportion of the time required for startup of the entire MFP. Therefore, in the conventional MFPs, warm-up of the fixing device is preferentially carried out.

However, recent MFPs are multi-functional and have more complex configurations and therefore take longer time to start up other units than the fixing device. Meanwhile, with the improvement in temperature control techniques for the fixing device, time taken for warm-up of the fixing device is reduced. Therefore, in some cases, the startup time for other units is longer than the required warm-up time for the fixing device. In such cases, after the fixing device reaches a target temperature, there is unnecessary power consumption to maintain the target temperature.

Thus, to prevent the unnecessary power consumption to maintain the target temperature, a technique of delaying the timing of starting the warm-up of the fixing device from the timing of starting the startup of other units is proposed, for example, as disclosed in Japanese Patent Application No.2007-322708.

However, the conventional MFPs perform control to heat the fixing device with a maximum quantity of heat during warm-up so that the target temperature in a standby state is reached within a minimum time after the acquisition of a startup request. Therefore, even when the warm-up of the fixing device is controlled to be completed simultaneously with the startup of other units, overshoot occurs in some cases, in which the temperature of the fixing device rise further after the target temperature is reached. Further power consumption is necessary to solve the resulting overshoot.

### SUMMARY

To solve the foregoing problems, according to an aspect of the invention, an image forming apparatus includes: a fixing device temperature information acquisition unit which acquires information about temperature of a fixing device; and a fixing device heating control unit which controls heating of the fixing device at least on the basis of the information about the temperature of the fixing device acquired by the temperature information acquisition unit so that the fixing device reaches a target temperature within a time period from first timing by which an operation input to start copying becomes acceptable to second timing by which a printing command for copying is issued.

According to another aspect of the invention, an image forming apparatus includes: a fixing device temperature information acquisition unit which acquires information about temperature of a fixing device; and a fixing device heating control unit which controls heating of the fixing device at least on the basis of the information about the temperature of the fixing device acquired by the temperature information acquisition unit so that the fixing device reaches a target temperature within a time period from timing by which an operation input to start copying becomes acceptable to pickup start timing when pickup of a storage medium is executed.

According to still another aspect of the invention, a fixing device heating method includes: acquiring information about temperature of a fixing device; and controlling heating of the fixing device at least on the basis of the acquired information about the temperature of the fixing device so that the fixing device reaches a target temperature within a time period from first timing by which an operation input to start copying becomes acceptable to second timing by which a printing command for copying is issued.

### DESCRIPTION OF THE DRAWINGS

FIG. 1 is a vertical sectional view showing the schematic configuration of an MFP (multi-function peripheral) according to a first embodiment.

FIG. 2 is a block diagram showing the hardware configuration of the MFP according to the first embodiment.

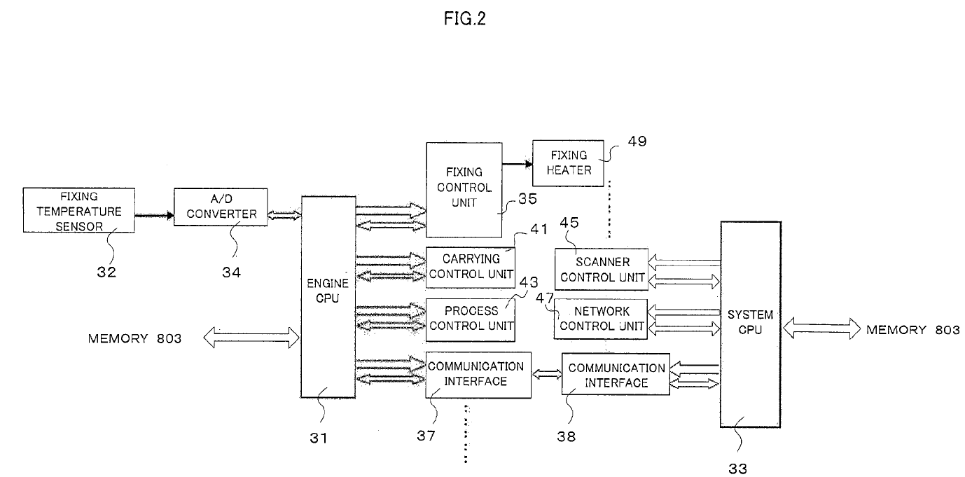

FIG. 3 is a timing chart in the case of startup from the power off mode in the first embodiment.

FIG. 4 is a timing chart in the case of startup from the sleep mode in the first embodiment.

FIG. 5 shows a processing flow of startup in the first embodiment.

FIG. 6 shows a processing flow of setting heating conditions according to the operation mode before the startup in the first embodiment.

FIG. 7 shows power consumption and the temperature of a fixing device 7 in the case where heating conditions are set according to the operation mode before the startup.

FIG. 8 is a block diagram showing the hardware configuration of an MFP according to a second embodiment.

FIG. 9 is a timing chart in the case of startup from the power off mode in the second embodiment.

FIG. 10 is a timing chart in the case of startup from the sleep mode in the second embodiment.

FIG. 11 shows a processing flow of startup in the second embodiment.

FIG. 12 shows an example of startup completion time Ts and target temperature reaching time Th stored in an HDD 804 corresponding to the operation mode of an MFP according to another embodiment.

FIG. 13 shows an example of heating conditions stored in an HDD 804 corresponding to fixing temperature information in an MFP according to another embodiment.

FIG. 14 is a block diagram showing the hardware configuration of an MFP according to another embodiment.

FIG. 15 is a block diagram showing the hardware configuration of an MFP according to another embodiment.

### DETAILED DESCRIPTION

Hereinafter, embodiments will be described with reference to the drawings.

### First Embodiment

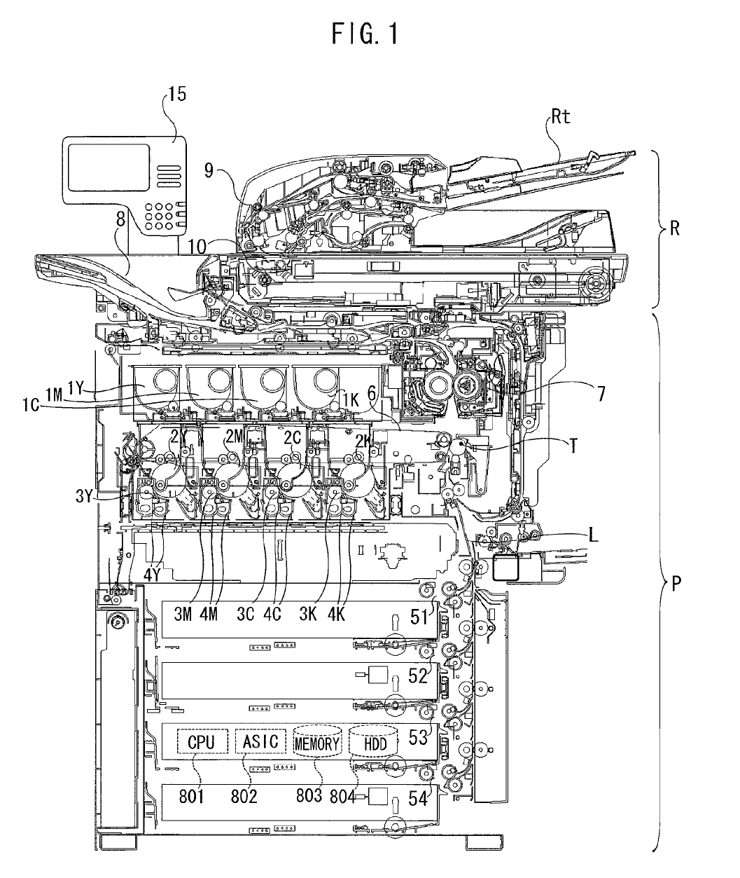

FIG. 1 is a vertical sectional view showing the schematic configuration of an MFP (multi-function peripheral) as an example of an image forming apparatus according to a first embodiment.

In the first embodiment, the MFP has two operation modes, that is, a standby mode in which image formation (image output) onto a storage medium (sheet) is being executed or the execution is waited for, and a sleep mode in which heating of the fixing device is stopped and electrification of a part of hardware involved in image scanning and the like is stopped as well. In the following description, to make understanding easier, also the state where electrification from a power source is off is assumed as an operation mode of the MFP. The operation mode in the case where the power source is off is referred to as a power off mode.

In the first embodiment, the MFP sets heating conditions for the fixing device so that the fixing device reaches a target temperature in timing (which will be described later in detail and is equivalent to third timing) when system startup is completed, the timing being decided in accordance with the operation mode (operation state) of the MFP when a startup start request is acquired. The timing when system startup is completed exists between timing when an operation input to start copying becomes acceptable (first timing) and timing when a printing command for copying becomes issuable (second timing).

In this specification, reaching a target temperature means that the fixing device reaches a target temperature for the first time after heating of the fixing device is started.

As shown in FIG. 1, the MFP according to the first embodiment has an image scanning unit R and an image forming unit P.

The image scanning unit R has the function of scanning an image of a sheet document and a book document.

The image forming unit P has the function of forming a developer image on a sheet on the basis of an image scanned from an original document by the image scanning unit R or image data or the like transmitted to the MFP from an external device.

The image scanning unit R has an ADF (automatic document feeder) 9 capable of automatically carrying an original document to a predetermined image scanning position. An image of an original document placed on a document tray (predetermined document placing table) Rt or a document placed on a document table, not shown, which is automatically carried by the automatic document feeder 9, is scanned by a scanning optical system 10.

The image forming unit P has pickup rollers 51 to 54, photoconductive members 2Y to 2K, developing rollers 3Y to 3K, mixers 4Y to 4K, an intermediate transfer belt 6, a fixing device 7, a discharge tray 8, toner cartridges 1Y to 1K (coloring agent cartridges), and a laser unit L.

The MFP according to the first embodiment also has a CPU 801, an ASIC (application specific integrated circuit) 802, a memory 803, and an HDD (hard disk drive) 804, as shown in FIG. 1. The CPU 801 plays the role of performing various kinds of processing in the MFP and also plays the role of realizing various functions by executing a program that is temporarily stored in the memory 803. As a matter of course, the CPU 801 can be replaced by an MPU (micro processing unit) that can execute equivalent arithmetic operation. Similarly, the HDD 804 can be replaced, for example, by a memory device such as a flash memory.

The ASIC 802 is equipped with hardware (circuit) to control various functions provided for the MFP (which will be described later in detail).

The memory 803 can include, for example, a RAM (random access memory), ROM (read only memory), DRAM (dynamic random access memory), SRAM (static random access memory), VRAM (video RAM) or the like and plays the role of temporarily storing various information and programs used in the MFP and log information of executed processing and so on.

The MFP according to the first embodiment also has an operation unit 15 by which a user can input requests about various kinds of processing to the MFP. The operation unit 15 includes a power switch to switch the electrification state (on or off) of the MFP from a power source, not shown, a graphical display equipped with a touch panel sensor, processing input buttons which are frequently used such as numeric value, start and cancel buttons, a state display LED, and so on.

In the following description, if the power switch is pressed, it is assumed that a startup start request to shift from the power off mode to the standby mode is inputted.

In the first embodiment, the operation state of the MFP may be a sleep mode in some cases. In the first embodiment, if one of the buttons in the operation unit 15, for example, a processing input button to execute copying, is pressed by the user, the MFP assumes that a startup start request to shift from the sleep mode to the standby mode is inputted, and thus executes startup.

Hereinafter, an outline of copying will be described as an example of processing in the MFP according to the first embodiment. When executing the copying, the MFP is operating in the standby mode as described above.

First, a sheet picked up from a cassette by the pickup rollers 51 to 54 is supplied into a sheet carrying path. The sheet supplied in the sheet carrying path is carried in a predetermined carrying direction by plural roller pairs.

Then, images of plural sheet documents that are continuously automatically carried by the automatic document feeder 9 are scanned by the scanning optical system 10 at a predetermined image scanning position.

Next, on the basis of image data of the images scanned from the original document by the image scanning unit R, electrostatic latent images are formed by the laser unit L on the photoconductive surfaces of the photoconductive members 2Y, 2M, 2C and 2K for transferring developer images of yellow (Y), magenta (M), cyan (C) and black (K) to the sheet.

Subsequently, developers stirred by the mixers 4Y to 4K (equivalent to stirring units) in the developing units are supplied by the developing rollers (so-called magnetic rollers) 3Y to 3K to the photoconductive members 2Y to 2K on which the electrostatic latent images are formed as described above. Whereby, the electrostatic latent image formed on the photoconductive surfaces of the photoconductive members are developed. Toners are supplied to these developing units by toner cartridges 9Y to 9K.

The developer images formed on the photoconductive members in this manner are transferred onto the belt surface of the intermediate transfer belt 6 (so-called primary transfer). The developer images carried by the turn of the intermediate transfer belt are transferred onto the carried sheet at a predetermined secondary transfer position T.

The developer images transferred onto the sheet are heated and fixed to the sheet by pressurization using a heating roller in the fixing device 7.

The sheet to which the developer images are heated and fixed is carried through the carrying path by the plural carrying roller pairs and sequentially discharged onto the discharge tray 8.

Next, the hardware configuration of the MFP according to the first embodiment will be described. In the MFP according to the first embodiment, processing that can be executed in the MFP is controlled by hardware arranged in the CPU 801 and the ASIC 802.

The CPU 801 executes a boot program, a driver program, and an application program or the like read out to the memory 803 from the HDD 804 in which these programs are stored in advance, and thereby realizes various processing functions.

Here, in the first embodiment, the MFP has an engine CPU 31 and a system CPU 33, as the CPU 801.

The engine CPU 31 starts up using various programs read out to the memory 803 from the HDD 804 in which these programs are stored in advance, on the basis of a startup start request to shift from the power off mode or the sleep mode to the standby mode. Then, the engine CPU 31 controls the hardware arranged in the ASIC 802 for image formation onto a sheet executed by the image forming unit R using various programs. For example, when control of each piece of hardware is made possible by the progress of startup of the engine CPU 31, the engine CPU 31 sends out a control signal to start startup of each piece of hardware.

The engine CPU 31 also acquires fixing temperature information indicating the temperature of the fixing device 7 (specifically, the heating roller of the fixing device 7) from a fixing temperature sensor 32 arranged in the fixing device 7. An electrical signal outputted from the fixing temperature sensor 32 is an analog signal. This analog signal is converted to a digital signal by an A/D converter 34 and sent to the engine CPU 31. In the first embodiment, when the MFP acquires a startup start request, the fixing temperature sensor 32 starts its startup under the control of the engine CPU 31. After the startup is completed, the fixing temperature sensor 32 sends fixing temperature information to the engine CPU 31.

The engine CPU 31 sets heating conditions for the fixing device 7 so that the temperature of the fixing device 7 reaches a target temperature in timing when system startup is completed, as will be described later, by using the fixing temperature information acquired from the fixing temperature sensor 32. Thus, the engine CPU 31 controls heating of the fixing device 7. The setting of the heating conditions is carried out if the time period from the acquisition of the startup request by the engine CPU 31 to the completion of the startup is longer than the time period from the acquisition of the startup request to the fixing device 7 reaches a target temperature (for example, 180° C.), as will be described later.

That is, the engine CPU 31 according to the first embodiment is equivalent to a fixing device temperature information acquisition unit, a fixing device heating control unit, and a determination unit.

The system CPU 33, similarly to the engine CPU 31, starts its startup using various programs read out to the memory 803 from the HDD 804 in which these programs are stored in advance, on the basis of a startup start request. Then, the system CPU 33 controls image scanning from an original document executed by the image scanning unit R, and communication, facsimile communication and the like with other devices via a network, by using various programs.

In response to the establishment of communication between the engine CPU 31 and the system CPU 33, which will be described later, the system CPU 33 generates pre-startup operation information, that is, information indicating the operation state of the MFP before the startup start request is acquired, on the basis of the log information of processing stored in the memory 803, and sends the pre-startup operation information to the engine CPU 31.

That is, the system CPU 33 according to the first embodiment is equivalent to an operation state acquisition unit.

A fixing control unit 35 controls the operation of the fixing device 7 under the control of the engine CPU 31. Here, in the first embodiment, the engine CPU 31 sets specific heating conditions for the fixing control unit 35 to perform heating control of the fixing device 7. The fixing control unit 35 controls a fixing heater 49 which heats the fixing device 7 on the basis of the heating conditions set by the engine CPU 31, and thus heats the heating roller provided in the fixing device 7.

Communication interfaces 37 and 38 are hardware which executes communication between the engine CPU 31 and the system CPU 33. Startup of the communication interfaces 37 and 38 are started under the control of the engine CPU 31 or the system CPU 33, and on completion of the startup, establish communication between the engine CPU 31 and the system CPU 33 (hereinafter, simply referred to as communications between the CPUs).

In addition, the MFP has hardware to realize functions provided for the MFP. As an example, the MFP has a carrying control unit 41, a process control unit 43, a scanner control unit 45 and a network control unit 47, in addition to the fixing control unit 35 and the communication interfaces 37 and 38.

The carrying control unit 41 executes control of sorting and carrying of a storage medium on which an image is formed by the image forming unit R, under the control of the engine CPU 31.

The process control unit 43 executes control of the photoconductive drums, light source, charger and exposing device in the image forming unit R under the control of the engine CPU 31.

The scanner control unit 45 executes control of image scanning from an original document in the image scanning unit P under the control of the system CPU 33.

The network control unit 47 executes control of communication between the MFP and other devices via a network such as a LAN under the control of the system CPU 33.

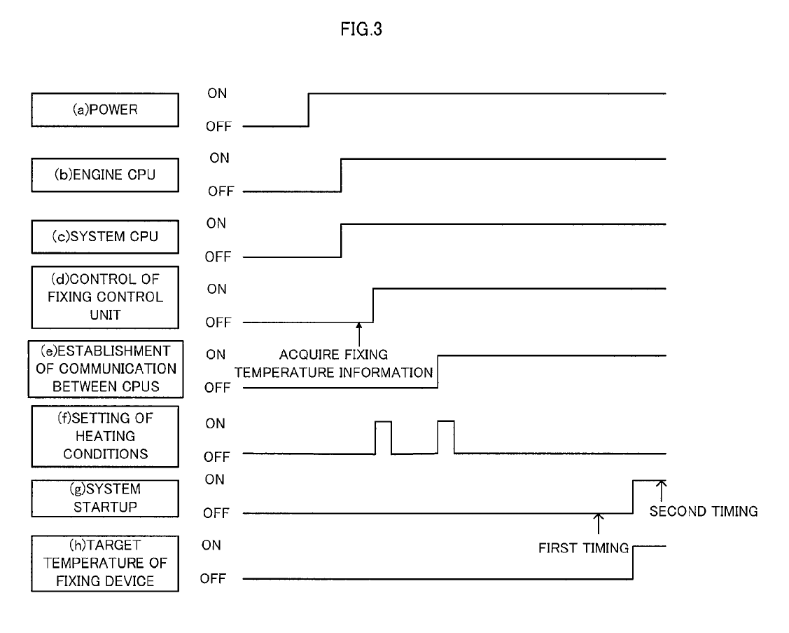

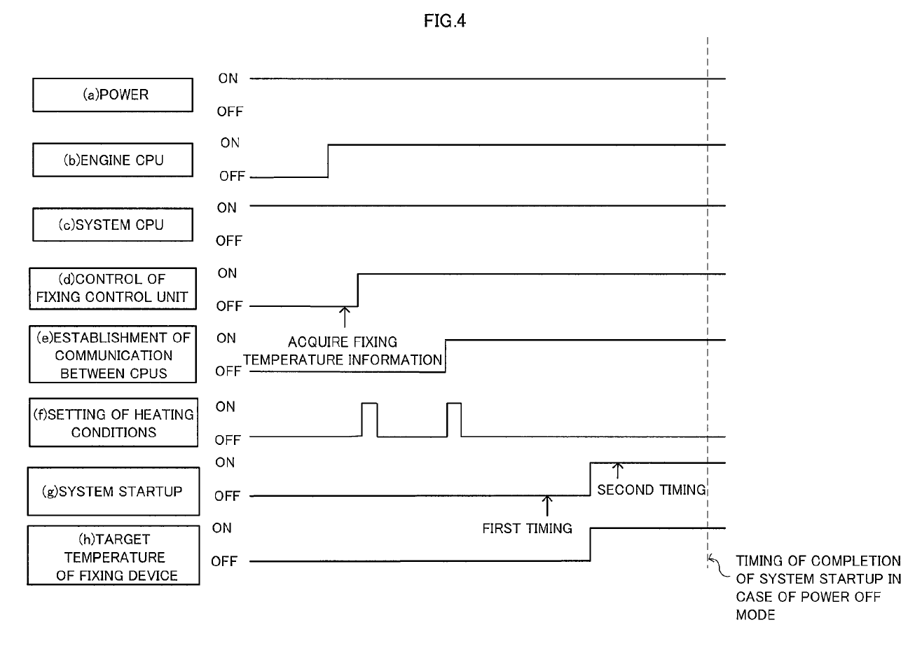

Next, the startup in the MFP according to the first embodiment will be described with reference to FIG. 3 and FIG. 4. FIG. 3 and FIG. 4 are timing charts showing the startup state of the MFP and various kinds of hardware in the MFP, and various kinds of processing. Here, in FIG. 3 and FIG. 4, (a) is a timing chart showing the electrification state of the MFP. (b) is a timing chart showing the startup state of the engine CPU 31. (c) is a timing chart showing the startup state of the system CPU 33. (d) is a timing chart showing the control state of the fixing control unit 35 by the engine CPU 31. (e) is a timing chart showing the state of establishment of communication between the CPUs. (f) is a timing chart showing the execution state of setting of heating conditions for the fixing device 7 by the engine CPU 31. (g) is a timing chart showing the state of startup of the system CPU 33 and each application controlled by the system CPU 33 (hereinafter, simply referred to as system startup). Timing indicated as ON corresponds to timing when the system startup is completed. (h) is a timing chart with respect to the temperature state of the fixing device 7. Timing indicated as ON corresponds to timing when the fixing device 7 reaches a target temperature.

FIG. 3 is a timing chart in the case of shifting from the power off mode to the standby mode. FIG. 4 is a timing chart in the case of shifting from the sleep mode to the standby mode. In the first embodiment, it is assumed that the startup of the fixing temperature sensor 32 is completed before the engine CPU 31 becomes able of controlling the fixing control unit 35. Therefore, the engine CPU 31 acquires fixing temperature information preceding the start of heating, before the timing when the engine CPU 31 becomes able to control the fixing control unit 35 (the acquired fixing temperature information is stored in the memory 803).

First, the case where the MFP shifts from the power off mode to the standby mode will be described. In FIG. 3, electrification is started as the power switch is pressed by the user's operation (power ON), as shown in (a). Next, in response to the start of electrification, startup is started in the engine CPU 31 and the system CPU 33, as shown in (b) and (c).

Next, the engine CPU 31 sets heating conditions for the fixing device 7 in timing when the engine CPU 31 becomes able to control the fixing control unit 35 as the startup of the engine CPU 31 proceeds, as shown in (d). In accordance with the set heating conditions, the fixing control unit 35 controls heating of the fixing device 7.

Next, the engine CPU 31 and the system CPU 33 establish communication between the CPUs in response to the completion of the startup of the communication interfaces 37 and 38, as shown in (e). As the communication between the CPUs is established, the engine CPU 31 executes setting of heating conditions for the fixing device 7 corresponding to the operation mode before the start of the startup (before the MFP acquires a startup start request) (which will be described later in detail). In the first embodiment, when setting heating conditions for the fixing device 7 in accordance with the operation mode before the start of the startup, the engine CPU 31 sets heating conditions so that the fixing device 7 reaches a target temperature simultaneously with the completion of the system startup, as shown in (g) and (h).

As shown in FIG. 3, the MFP according to the first embodiment becomes able to accept a copying operation input, which is one of the provided functions, as the system startup proceeds. The MFP according to the first embodiment also becomes able to issue a printing command for copying after the system startup is completed.

Next, the case of shifting from the sleep mode to the standby mode in the MFP will be described. Common parts with the case of shifting from the power off mode to the standby mode will not be described further in detail. In FIG. 4, the electrification of the MFP is maintained in the sleep mode, as shown in (a). The system CPU 33 is started up as well, as shown in (c). Therefore, as shown in (g), the system startup is completed more quickly than in the case of shifting from the power off mode to the standby mode shown in FIG. 3. That is, the timing when the system startup is completed varies depending on the operation state (operation mode) of the MFP before a startup start request is acquired. Meanwhile, the engine CPU 31 is not started up yet, as shown in (b). In response to the acquisition of a startup start request to shift from the sleep mode to the standby mode, startup of the engine CPU 31 is carried out.

Next, the setting of heating conditions corresponding to the operation mode before the start of the startup, carried out in the engine CPU 31 following the establishment of communication with the system CPU 33, will be described specifically.

First, the engine CPU 31 acquires pre-startup operation information generated on the basis of log information stored in the memory 803, from the system CPU 33. On the basis of the pre-startup operation information, the engine CPU 31 determines whether the operation mode of the MFP before starting the startup is the power off mode or not. Next, in accordance with the result of the determination, the engine CPU 31 calculates a startup completion time Ts, which is the completion time of the system startup (the time from timing when the acquisition of a startup start request to timing when the completion of the system startup).

The startup completion time Ts can be calculated on the basis of a predicted completion time of startup of the CPU 801 (the engine CPU 31 and the system CPU 33) and each piece of hardware controlled by the CPU 801, which is stored, for example, in the HDD 804 in advance and read out to the memory 803 from the HDD 804.

The engine CPU 31 then calculates a target temperature reaching time Th from timing when the acquisition of the startup start request to timing when the fixing device 7 reaches a target temperature in the case where the fixing device 7 is heated under the currently executed heating conditions. The target temperature reaching time Th can be calculated on the basis of, for example, fixing temperature information before the execution of heating, acquired from the fixing temperature sensor 32, the time taken from the acquisition of the startup request to the start of heating of the fixing device 7, the currently executed heating conditions for the fixing device 7, and the target temperature of the fixing device 7.

In the first embodiment, the heating conditions (specifically, the quantity of power supplied to the fixing heater 49) set and executed when the engine CPU 31 becomes able to control the fixing control unit 35, and the target temperature of the fixing device 7 (the temperature of the fixing device 7 when the MFP is in the standby mode) are stored in the HDD 804 in advance and are read out from the HDD 804 to the memory 803 and used there. The engine CPU 31 acquires such information from the memory 803 and sets heating conditions in timing when the engine CPU 31 becomes able to control the fixing control unit 35. In the following description, the information about heating conditions that are set and executed when the engine CPU 31 becomes able to control the fixing control unit 35 is referred to as initial heating information. The quantity of power supplied to the fixing heater 49, set by the initial heating information, can be, for example, the maximum quantity of power that can be supplied to the fixing heater 49.

Next, the engine CPU 31 determines whether the relation of the startup completion time Ts>the target temperature reaching time Th holds or not. When the relation of the startup completion time Ts>the target temperature reaching time Th holds, the engine CPU 31 sets heating conditions for the fixing device 7 so that the temperature of the fixing device 7 reaches the target temperature in timing when the system startup is completed. Specifically, the quantity of power supplied to the fixing heater 49 per unit time is set to be smaller than the quantity of power based on the heating conditions executed when the communication between the CPUs is established. The quantity of power per unit time in this case can be calculated, for example, on the basis of the startup completion time Ts, the target temperature reaching time Th, the fixing temperature information and the initial heating information.

In the first embodiment, the timing of setting heating conditions according to the operation mode before the start of the startup differs between the case of shifting from the power off mode to the standby mode and the case of shifting from the sleep mode to the standby mode, as shown in FIG. 3 and FIG. 4.

Next, the processing flow of the startup in the first embodiment will be described.

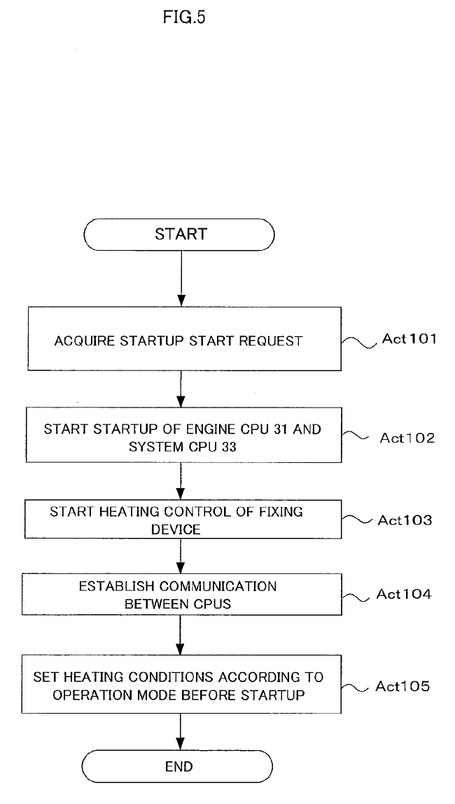

As shown in FIG. 5, first, in Act 101, the engine CPU 31 and the system CPU 33 acquire a startup start request in accordance with an input from the user. Specifically, when the power switch is pressed, the engine CPU 31 and the system CPU 33 assume that there is a startup start request to shift from the power off mode to the standby mode. Moreover, as one of the buttons in the operation unit 15 is pressed, the engine CPU 31 and the system CPU 33 assume that a startup start request to shift from the sleep mode to the standby mode is inputted. Next, in Act 102, the engine CPU 31 and the system. CPU 33 start the startup, respectively.

Next, in Act 103, when the engine CPU 31 becomes able to control the fixing control unit 35 as its started startup proceeds, the engine CPU 31 sets heating conditions based on the initial heating information reads out to the memory 803 and starts heating control of the fixing device 7. Next, in Act 104, as the startup of the communication interfaces 37 and 38 is completed, the engine CPU 31 and the system CPU 33 establish communication between the CPUs. Then, in Act 105, the engine CPU 31 executes the setting of heating conditions for the fixing device 7 according to the operation mode before the start of the startup. Then, the fixing control unit 35 performs heating control until the fixing device 7 reaches the target temperature, and then adjusts the quantity of current to control the heating conditions so that the target temperature is maintained in the fixing device 7.

Next, the processing flow for the re-setting of heating conditions for the fixing device 7 in the first embodiment will be described more specifically.

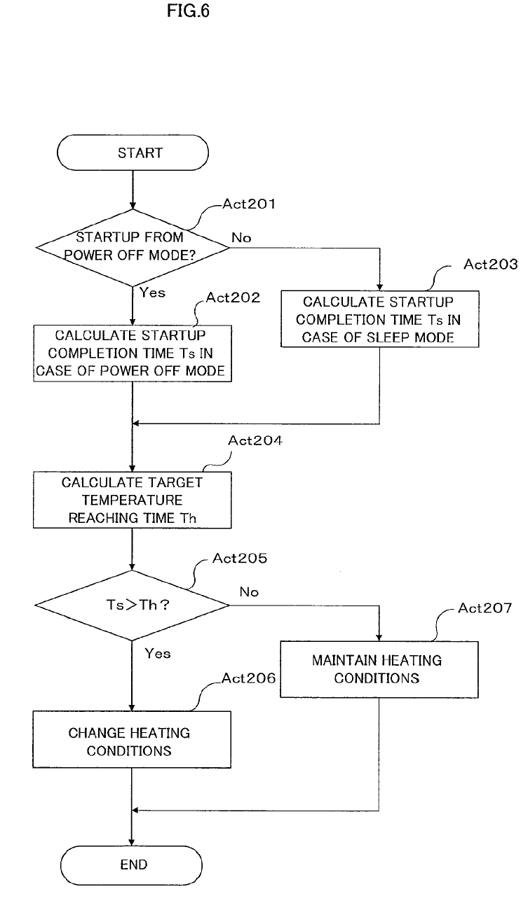

As shown in FIG. 6, in Act 201, the engine CPU 31 determines whether the MFP is started up from the power off mode or not. If it is determined that the MFP is started up from the power off mode (Yes in Act 201), the engine CPU 31 in Act 202 calculates the startup completion time Ts in the case of the startup from the power off mode.

Meanwhile, it is determined in Act 201 that the MFP is not started up from the power off mode (No in Act 201), the engine CPU 31 in the Act 203 calculates the startup completion time Ts in the case of the startup from the sleep mode.

Next, in Act 204, the engine CPU 31 calculates the target temperature reaching time Th.

Next, in Act 205, the engine CPU 31 determines whether the relation of the startup completion time Ts>the target temperature reaching time Th holds or not. If the relation of the startup completion time Ts>the target temperature reaching time Th holds (Yes in Act 205), the engine CPU 31 in Act 206 executes the setting of heating conditions according to the operation mode before the start of the startup. As for the re-setting of the heating conditions, in the first embodiment, the heating conditions for the fixing device 7 are set so that the temperature of the fixing device 7 reaches the target temperature in timing when the system startup is completed. Meanwhile, if the relation of the startup completion time Ts>the target temperature reaching time Th does not hold (No in Act 205), the engine CPU 31 in Act 207 controls the fixing control unit 35 so that the fixing device 7 is heated under the currently executed initial heating conditions (maintenance of the heating conditions).

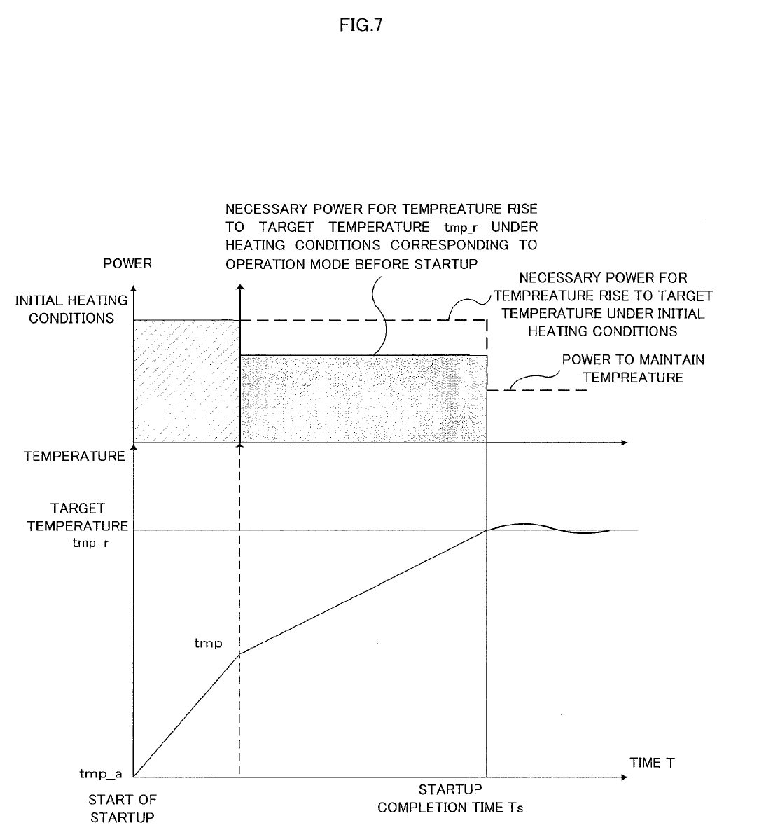

As described above, according to the first embodiment, heating conditions can be re-set according to the operation mode before the MFP's shift to the standby mode. Therefore, the quantity of power consumption can be reduced compared to the conventional technique, as shown in FIG. 7. Second Embodiment

Now, a second embodiment will be described. Parts of the configuration that are common with the first embodiment are denoted by the same reference numerals and will not be described further in detail. In the second embodiment, in the sleep mode, neither the engine CPU 31 nor the system CPU 33 is started up and only a startup CPU 39 is started up, which will be described later.

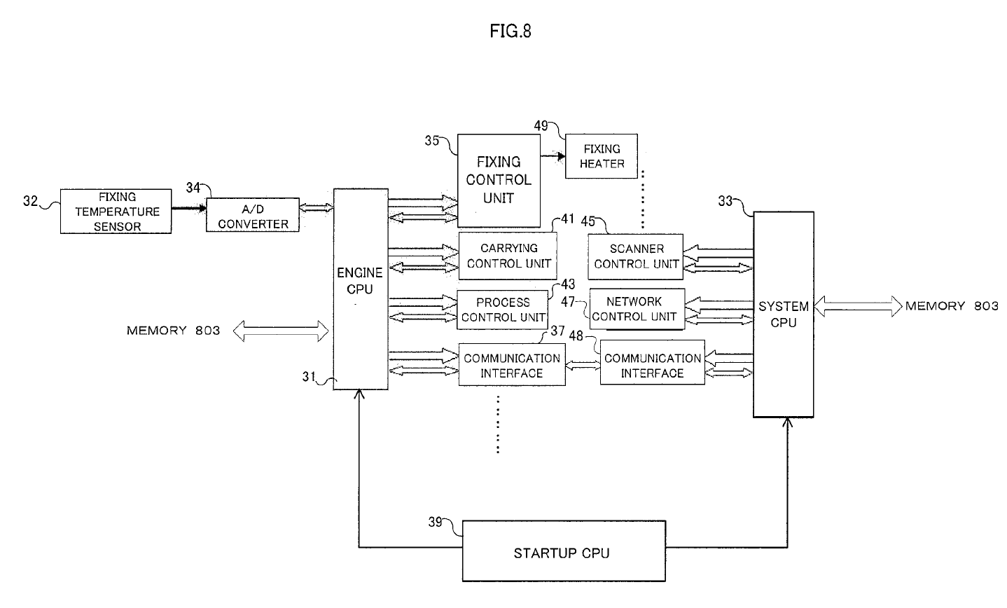

FIG. 8 shows the hardware configuration of an MFP according to the second embodiment. In the second embodiment, the MFP further has the startup CPU 39 in addition to the configuration described in the first embodiment.

In the second embodiment, in response to a startup start request, the startup CPU 39 starts its own startup. Then, after the completion of the startup, the startup CPU 39 sends out a control signal to start startup of the engine CPU 31 and the system CPU 33.

The startup CPU 39 also generates information (pre-startup operation information) indicating the operation state of the MFP before acquiring the startup request, on the basis of log information about processing stored in the memory 803 and sends out the information together with the control signal to the engine CPU 31.

The pre-startup operation information can be, for example, two kinds of commands that enable distinction between the case of the power off mode and the case of the sleep mode, as a signal when the startup CPU 39 starts the startup of the engine CPU 31. In this case, the engine CPU 31 is connected to the HDD 804 and may determine whether the operation mode before the startup is the power off mode or not, by using information about the commands corresponding to the information about the operation mode, which is stored in the HDD 804 and read out to the memory 803 by the start up.

That is, in the second embodiment, the startup CPU 39 is equivalent to an operation state acquisition unit.

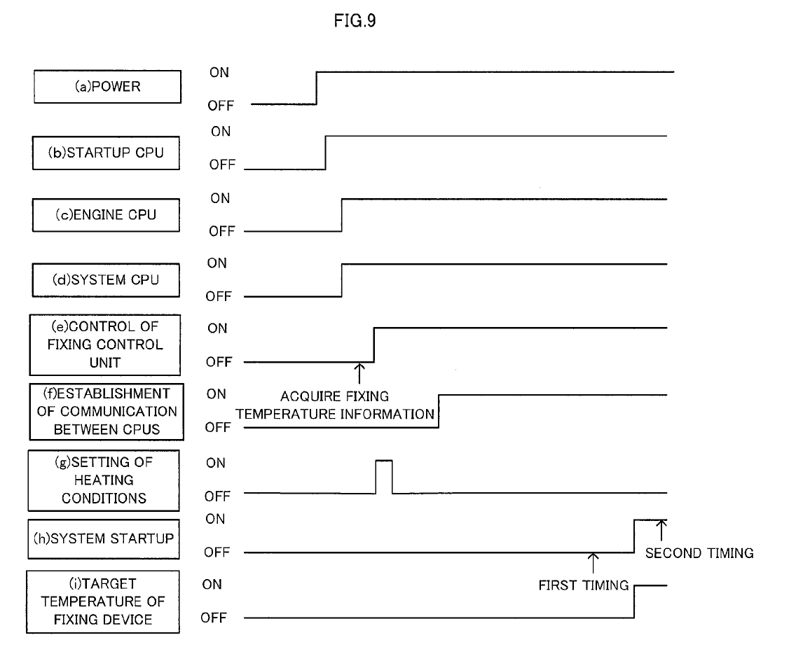

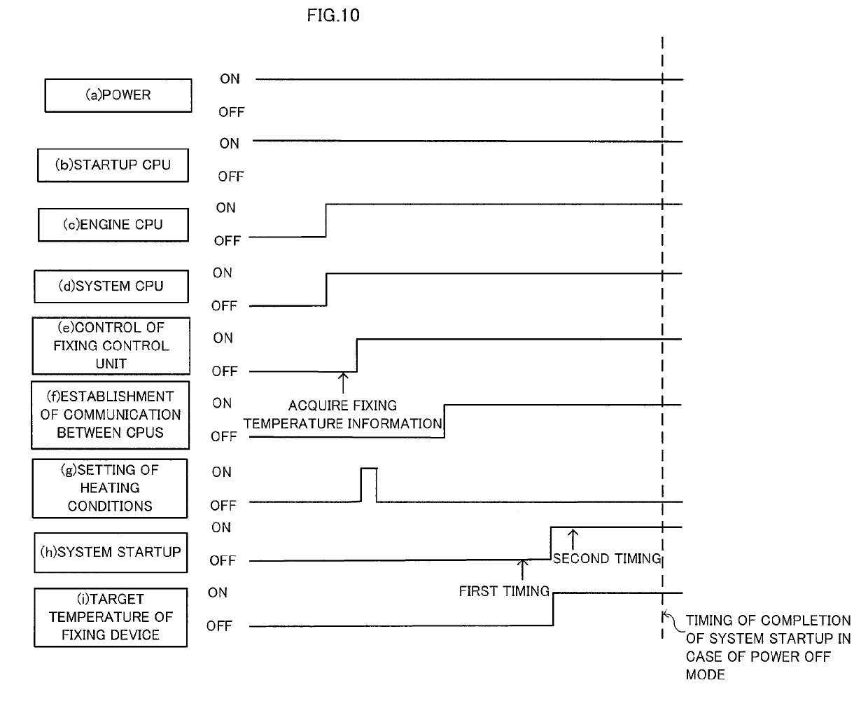

Next, the startup operation in the MFP according to the second embodiment will be described with reference to FIG. 9 and FIG. 10. Here, in FIG. 9 and FIG. 10, (a) and (c) to (h) are timing charts with respect to common elements with the timing charts (a) to (h) of FIG. 3 and FIG. 4 showing the startup state of the MFP and various hardware in the MFP and various kinds of processing. In FIG. 9 and FIG. 10, (b) is a timing chart showing the startup state of the startup CPU 39.

As in the first embodiment, FIG. 9 is a timing chart in the case of shifting from the power off mode to the standby mode. FIG. 10 is a timing chart in the case of shifting from the sleep mode to the standby mode.

When the MFP shifts from the power off mode to the standby mode, first, electrification is started as the power switch is pressed by the user's operation, as shown in (a) of FIG. 9. Next, in response to the start of the electrification, the startup CPU 39 starts its startup, as shown in (b). Then, as the startup of the startup CPU 39 is completed, a control signal is sent out and each of the engine CPU 31 and the system CPU 33 starts startup, as shown in (c) and (d).

Next, the engine CPU 31 sets heating conditions for the fixing device 7 in timing when the engine CPU 31 becomes able to control the fixing control unit 35 in the startup of the engine CPU 31, as shown in (e). The engine CPU 31 controls the fixing control unit 35 in accordance with the heating conditions.

Then, the engine CPU 31 and the system CPU 33 establish communication in response to the completion of the startup of the communication interfaces 37 and 38 (establishment of communication between the CPUs), as shown in (f).

Meanwhile, when the MFP shifts from the sleep mode to the standby mode, electrification of the MFP is maintained and the startup CPU 39 is started up, as shown in (a) and (b) of FIG. 10. However, the engine CPU 31 and the system CPU 33 are not started up, as shown in (c) and (d) and their startup is carried out in response to the acquisition of a startup start request to shift from the sleep mode to the standby mode. Specifically, the startup of the engine CPU 31 and the system CPU 33 is started under the control of the startup CPU 39.

Also in the case of shifting from the sleep mode to the standby mode, the engine CPU 31 sets heating conditions for the fixing device 7 in timing when the engine CPU 31 becomes able to control the fixing control unit 35 in the startup of the engine CPU 31, as shown in (d) of FIG. 10.

In this manner, in the second embodiment, heating conditions according to the operation mode before the start of the startup of the MFP can be set before communication between the CPUs (the engine CPU 31 and the system CPU 33) is established.

Next, the processing flow of the startup in the second embodiment will be described. The setting of heating conditions for the fixing device 7 is common with the case described in the first embodiment with reference to FIG. 6 and therefore will not be described further in detail, except for sending out of pre-startup operation mode information from the startup CPU 39 to the engine CPU.

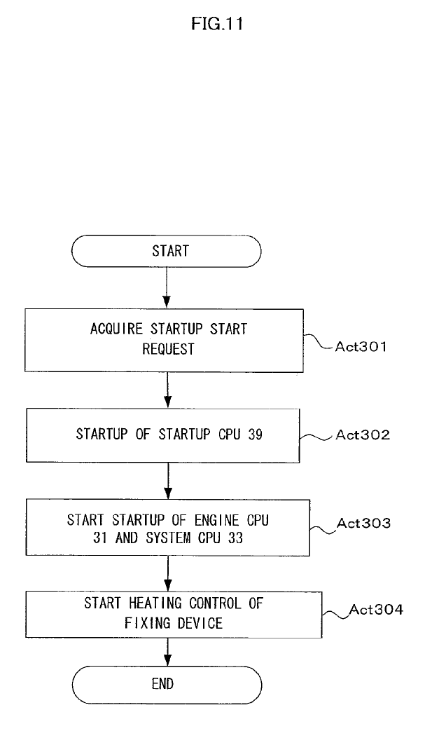

As shown in FIG. 11, first, the startup CPU 39 acquires a startup start request on the basis of an input from the user, in Act 301. Next, in Act 302, the startup CPU 39 starts its startup on the basis of the acquisition of the startup start request.

Next, in Act 303, when the startup is completed, the startup CPU 39 sends out a control signal to start the startup of the engine CPU 31 and the system CPU 33. At this time, the startup CPU 39 sends pre-startup operation information to the engine CPU 31 together with the control signal. In Act 304, the engine CPU 31 sets heating conditions for the fixing device 7 on the basis of the pre-startup operation information and fixing temperature information acquired from the fixing temperature sensor 32 and starts heating control of the fixing device 7.

The embodiments of the invention are described above. However, the invention is not limited to these embodiments and, of course, can employ other embodiments as well.

For example, in the first embodiment, the engine CPU 31 sets heating conditions so that the temperature of the fixing device 7 reaches the target temperature in timing when the system startup is completed. However, without being limited to this embodiment, the heating of the fixing device 7 can be controlled so that the fixing device 7 reaches the target temperature within the period from the timing when an operation input to start copying becomes acceptable (first timing) to the timing when a printing command for copying becomes issuable (second timing).

When the fixing device 7 reaches the target temperature in the first timing or later, time interval between the timing when the fixing device 7 reaches the target temperature and timing when MFP starts copying can be decreased. As a result, power consumption for maintaining warmed-up state in fixing device 7 can be reduced. In addition by the effect that the fixing device 7 reaches the target temperature by the second timing, power consumption for CPU801 including system CPU 33, ASIC802, and the like until the fixing in the MFP becomes workable can be reduced. Additionally, by the effect that the fixing device 7 reaches the target temperature between first timing and second timing, user's waiting time for copying and so on can be also reduced.

It can also be said that this time range can be the period between the timing when an operation input to start copying become acceptable to the pickup start timing when pickup of a sheet is executed. It can also be said that this time range is the period from the timing when an operation input to start copying becomes acceptable to the timing when transfer of image data to be outputted to a sheet, from the system CPU 33 to the engine CPU 31, is started. As well as the case where the fixing device 7 reaches the target temperature between the first and second timing, power consumption for maintaining warmed-up state in fixing device 7 and for CPU801, ASIC802, and the like until fixing in the MFP becomes workable can be reduced.

In the first and second embodiments, the timing when the system startup is completed is described as third timing. However, the third timing is not limited to this and can take other forms. For example, the first timing and the second timing may be set in accordance with the operation state before the MFP acquires the startup start request, and the third timing maybe set as a temporally middle value between the first timing and the second timing. Alternatively, the third timing may be set as the timing when startup of hardware operating for printing requested via network is completed, which is usually set later than the timing when an operation input to start copying becomes acceptable.

In the first and second embodiments, the engine CPU 31 sets heating conditions so that the temperature of the fixing device 7 reaches the target value in the third timing, with reference to the third timing arranged between the first timing and the second timing. However, of course, other embodiments can also be employed. It suffices that the temperature of the fixing device 7 reaches the target value between the first timing and the second timing. For example, the engine CPU 31 may acquire information about the first timing and the second timing and set heating conditions so that the temperature of the fixing device 7 reaches the target value between the first timing and the second timing.

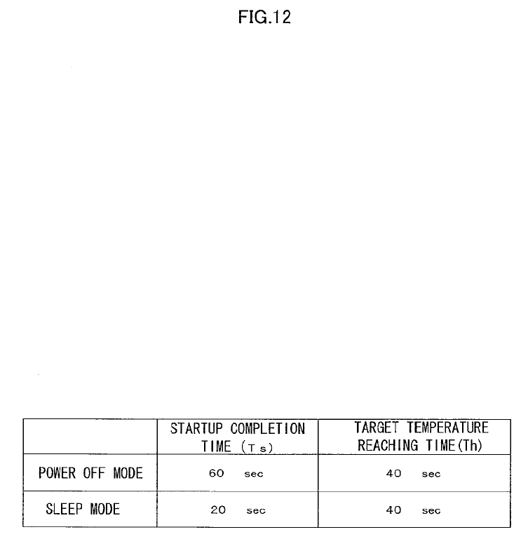

In the first and second embodiments, the startup completion time Ts and the target temperature reaching time Th are calculated in the setting of heating conditions, and the quantity of power supplied to the fixing heater 49 is subsequently calculated. However, without being limited to these embodiments, the operation mode of the MFP, and the startup completion time Ts and the target temperature reaching time Th according to each operation mode may be stored in the HDD 804 in association with each other and then read out to the memory 803 by the startup, for example, as shown in FIG. 12. The engine CPU 31 specifies the startup completion time Ts and the target temperature reaching time Th used to calculate the quantity of power, from the acquired pre-startup operation information and the startup completion time Ts and the target temperature reaching time Th that are stored in advance.

As a matter of course, those skilled in the art can understand that if the startup completion time Ts and the target temperature reaching time Th are stored in the HDD 804 or the like in advance, these times can be set on the basis of actual result data and the like.

In the first and second embodiments, engine CPU31 and the fixing control unit 35 control the process including the startup of fixing device 7, using the program and the like stored in HDD804 for facilitating the understanding. However, the embodiment cannot be limited to them. In another embodiment, for example, these programs and the like are stored in ROM separated from HDD804, and the engine CPU31 and the fixing control unit 35 may control the process including startup of the fixing device 7, using the programs stored in the ROM. Moreover, in the second embodiment, the standby mode and the sleep mode in which the system CPU is not started up are described as operation modes in which electrification is carried out. However, as an embodiment of the invention, still another operation mode can be included. For example, the sleep mode in the state where the system CPU 33 is started up, as described in the first embodiment, may be included as well.

Also, in the first and second embodiments, the information about the temperature of the heating roller of the fixing device 7 is acquired as fixing temperature information. However, without being limited to these embodiments, for example, the temperature of the pressurizing roller, the ambient temperature within the fixing device 7, or the temperature of the casing of the fixing device 7 may be acquired as well.

Moreover, in the first embodiment, heating conditions according to the operation mode of the MFP before the acquisition of the startup request are set after the heating of the fixing device 7 is started. However, without being limited to this embodiment, heating conditions according to the operation mode of the MFP before the acquisition of the startup request may be set before the heating of the fixing device 7 is started.

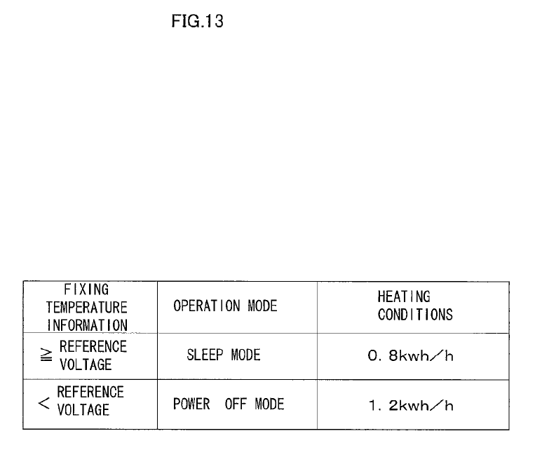

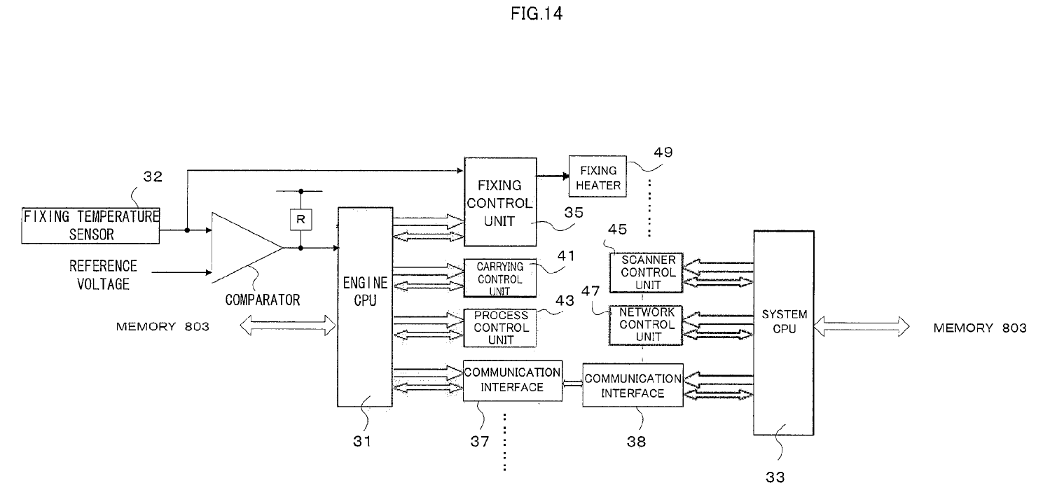

As still another embodiment, in a certain case, the time required for completion of the system startup does not change according to the difference in operation mode, depending on the configuration of the MFP. In this case, on the basis of the acquired fixing temperature information, heating conditions for the fixing device 7 can be set using the heating conditions stored in the HDD 804 in advance in association with the fixing temperature information, for example, as shown in FIG. 13, and then read out to the memory 803. In this case, for example, a hardware configuration as shown in FIG. 14 is employed. The result of comparison by a comparator between a voltage outputted from the fixing temperature sensor 32 and a determination reference voltage is acquired as fixing temperature information. Information about heating conditions for the fixing device is acquired on the basis of the fixing temperature information.

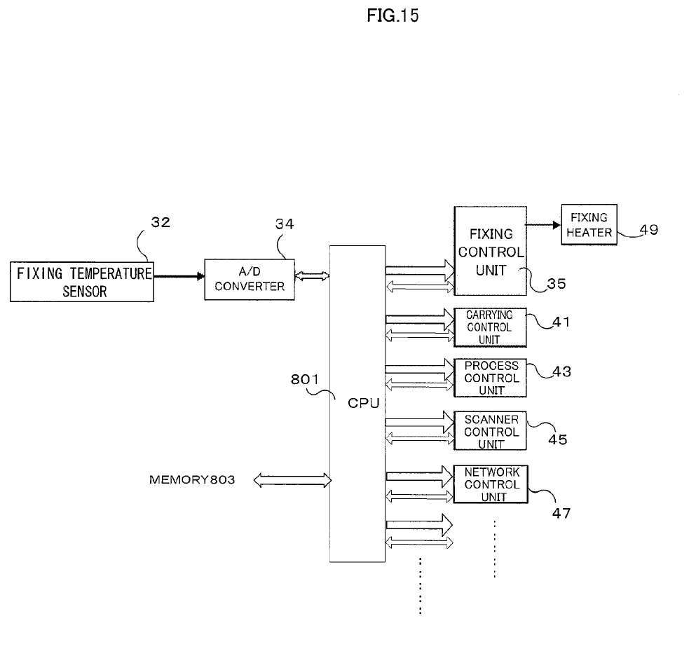

Moreover, in the first embodiment, the engine CPU 31 and the system CPU 33 are provided as the CPU 801. In the second embodiment, the startup CPU 39 i provided in addition the engine CPU 31 and the system CPU 33, as the CPU 801. However, as still another embodiment of the invention, of course, it is also possible to control processing with a single CPU 801 (or an MPU that can replace this CPU), as shown in FIG. 15. In this case, heating conditions according to the operation mode before the startup may be set before the heating of the fixing device 7 is started. Alternatively, the heating of the fixing device may be started under heating conditions that are set on the basis of the initial heating conditions, and heating conditions may be set again when, as the startup proceeds, the CPU 801 becomes able to acquire information for setting heating conditions according to the operation mode before the startup.

Also, a program which causes a processor such as the CPU 801 or the like constituting the image forming apparatus to execute each of the above operations can be provided as a control parameter correction method program. In the first embodiment, the program which realizes the functions to carry out the invention is recorded in advance in the memory area provided within the apparatus, as an example. However, without being limited to this example, a similar program may be downloaded to the apparatus from a network or a computer-readable recording medium having a similar program stored therein may be installed in the apparatus. As the recording medium, any form of medium that can store a program and can be read on a computer may be employed. Specifically, the recording medium may be, for example, an internal storage device that is internally loaded in a computer such as ROM or RAM, a portable storage medium such as CD-ROM, flexible disk, DVD disk, magneto-optical disk or IC card, a database which holds a computer program, another computer and its database, a transmission medium on a line, or the like. The functions that are thus installed or downloaded in advance maybe realized in cooperation with the OS (operating system) in the apparatus.

The program may partly or entirely be an execution module which is dynamically generated.

As a matter of course, the various kinds of processing realized by the execution of the program by the CPU or MPU in each of the above embodiments can also be executed by the ASIC 802 in the form of a circuit.

The invention can be carried out in various forms without departing from the spirit or principal features of the invention. Therefore, the above embodiments are simply examples in all respects and should not be understood as limiting the invention. The scope of the invention is defined by the attached claims and is not restricted by the specification at all. Moreover, all modifications, various improvements, alternatives and alterations that are equivalent to the claims fall within the scope of the invention.

As described above in detail, according to the embodiments, a technique to restrain the quantity of power consumption at the time of startup of the MFP can be provided.

What is claimed is:

1. An image forming apparatus comprising:
a fixing device temperature information acquisition unit which acquires information about temperature of a fixing device; and
a fixing device heating control unit which controls heating of the fixing device, using at least the information about the temperature of the fixing device acquired by the temperature information acquisition unit so that the fixing device reaches a target temperature within a time period from first timing by which an operation input to start copying becomes acceptable to second timing when a printing command for copying becomes issuable.

2. The apparatus according to claim 1, wherein the fixing device heating control unit further uses information about third timing that exists between the first timing and the second timing, the third timing being decided in accordance with an operation state of the image forming apparatus before the image forming apparatus acquires a startup start request, thus controls the heating of the fixing device so that the fixing device reaches the target temperature in the third timing.

3. The apparatus according to claim 2, further comprising an operation state acquisition unit which acquires pre-startup operation information about the operation state of the image forming apparatus before the image forming apparatus acquires the startup start request,
wherein the fixing device heating control unit acquires the information about the third timing on the basis of the pre-startup operation information acquired by the operation state acquisition unit.

4. The apparatus according to claim 2, further comprising a determination unit which determines whether or not a time period from timing when the image forming apparatus acquires the startup start request to the third timing is shorter than a time period from the timing when the image forming apparatus acquires the startup start request to timing when the fixing device reach the target temperature,
wherein the fixing device heating control unit controls the heating of the fixing device so that the fixing device reaches the target temperature in the third timing if it is determined by the determination unit that the time period from timing when the image forming apparatus acquires the startup start request to the third timing is shorter than the time period from the timing when the image forming apparatus acquires the startup start request to the timing when the fixing device reach the target temperature.

5. An image forming apparatus comprising:
a fixing device temperature information acquisition unit which acquires information about temperature of a fixing device; and
a fixing device heating control unit which controls heating of the fixing device, using at least the information about the temperature of the fixing device acquired by the temperature information acquisition unit so that the fixing device reaches a target temperature within a time period from timing by which an operation input to start copying becomes acceptable to pickup start timing when pickup of a storage medium is executed.

6. A fixing device heating method comprising:
acquiring information about temperature of a fixing device; and
controlling heating of the fixing device by using at least the acquired information about the temperature of the fixing device so that the fixing device reaches a target temperature within a time period from first timing by which an operation input to start copying becomes acceptable to second timing when a printing command for copying becomes issuable.

7. The method according to claim 6, wherein information about third timing that exists between the first timing and the second timing, the third timing being decided in accordance with an operation state of the image forming apparatus when the image forming apparatus acquires a startup start request, is further used to control the heating of the fixing device so that the fixing device reaches the target temperature in the third timing.

8. The method according to claim 7, wherein pre-startup operation information about the operation state of the image forming apparatus before the image forming apparatus acquires the startup start request is acquired, and
the information about the third timing is acquired on the basis of the acquired pre-startup operation information.

9. The method according to claim 7, wherein it is determined whether or not a time period from timing when the image forming apparatus acquires the startup start request to the third timing is shorter than a time period from the timing when the image forming apparatus acquires the startup start request to timing when the fixing device reach the target temperature, and
if it is determined that the time period from timing when the image forming apparatus acquires the startup start request to the third timing is shorter than the time period from the timing when the image forming apparatus acquires the startup start request to the timing when the fixing device reach the target temperature, the heating of the fixing device is controlled so that the fixing device reaches the target temperature in the third timing.
